(19) United States
(12) Patent Application Publication
(10) Pub. No.: US 2005/0083795 A1
(43) Pub. Date: Apr. 21, 2005

(54) Method for data transfer between systems connected to library apparatus, and library apparatus

(75) Inventors: Koichi Doi, Kawasaki (JP); Yukio Taniyama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/801,849

(22) Filed: Mar. 17, 2004

(30) Foreign Application Priority Data
Oct. 20, 2003 (JP) 2003-358691

(51) Int. Cl. G11B 7/085

(52) U.S. Cl. 369/30.27

(57) ABSTRACT

Work time for data transfer between a plurality of host computers is reduced by automatically notifying a host computer to which the data is transferred of insertion of the storage medium when a storage medium is conveyed from a housing unit to a turnout area.

### BACKGROUND OF THE INVENTION

1. Field of the Invention

The present invention relates to a library apparatus having a plurality of replaceable storage media housed therein and allowing reading or recording to be executed in response to requests from a host computer.

2. Description of the Related Arts

A library apparatus is an apparatus which is connected to a host computer for the purpose of backing up a large amount of data used in the host computer and in which a plurality of replaceable storage media are housed. The library apparatus includes a housing unit for installing a plurality of storage media, a drive for writing data into the storage media and for reading data recorded in the storage media and a robot for conveying the storage media. As the scale of the library apparatus becomes larger, the number of the storage media housed in the housing unit becomes increased and some library apparatuses have a plurality of drives and robots.

As a conventional technique concerning the library apparatus, a technique is known, in which a housing unit is logically divided into a plurality of its portions and one (1) library apparatus is used as if it were a plurality of library apparatuses respectively connected to a plurality of host computers (see, e.g., Japanese Patent Application Laid-open Pub. No. 1998-228352). In this case, each of the plurality of logically-divided portions of the housing units is respectively assigned to each of the plurality of host computers connected to the library apparatus. Each of the host computers respectively issues instruction orders (such as an instruction to convey a medium) for each of the logically-divided portions of the housing unit and makes accesses to the housing unit. In response to the accesses made to the housing unit, the library apparatus, for example, conveys a storage medium to the drive, writes data into the storage medium and transmits to a host computer the data read out from the storage medium. In this manner, a storage medium housed in the housing unit is used by a host computer. When a process at the drive has been completed, the storage medium is again conveyed to the housing unit.

Utilizing this library apparatus connected to the plurality of host computers, data may be transferred between host computers. Among the plurality of logically-divided portions of the housing unit, the portion of the housing unit in which a storage medium storing the data to be transferred is housed will be hereinafter referred to as “transfer origin housing unit”, the host computer capable of making accesses to a transfer origin housing unit as “transfer origin host computer”, the host computer to be the destination of the transfer of the data as “transfer destination host computer” and the housing unit to which a transfer destination host computer can make accesses as “transfer destination housing unit”. When the housing unit is logically divided, a transfer destination host computer can not use directly a storage medium housed in a transfer origin housing unit. Therefore, in order to transfer data, it is necessary to house a storage medium storing the data to be transferred, into the transfer destination housing unit.

However, conventionally, for transferring a storage medium from a transfer origin housing unit to a transfer destination housing unit, ejecting once from the library apparatus the storage medium housed in the transfer origin housing unit and inserting again the storage medium into the library apparatus is executed. By doing this, the insertion of the storage medium is notified to the transfer destination host computer. Due to the notification, the transfer destination host computer can recognize the storage medium storing the data to be transferred. Furthermore, it is necessary to operate an apparatus called volume access station through a manual procedure in order to eject/insert a storage medium from/into the library apparatus and, therefore, there is a problem that the number of steps and labor charge are increased.

### SUMMARY OF THE INVENTION

It is therefore the object of the present invention to provide a method for speeding up the procedure for data transfer between systems connected to a library apparatus and for reducing the work time necessary for data transfer.

In order to achieve the above object, according to a first aspect of the present invention there is provided a data transfer method effected in a library apparatus having a logically plurally divided housing unit, a turnout housing unit for housing temporarily a storage medium, and a robot for conveying the storage medium from the housing unit to the turnout housing unit or from the turnout housing unit to the housing unit, with a plurality of host computers being connected to the library apparatus, the plurality of host computers each making access to the logically plurally divided housing unit, the data transfer method enabling the storage medium housed in a first housing portion of the logically plurally divided housing unit to be used by the host computer making access to a second housing portion different from the first housing portion, the method comprising the steps of controlling the robot to convey the storage medium from the first housing portion to the turnout housing unit based on a medium conveyance instruction from a first host computer making access to the first housing portion; after completion of the conveyance to the turnout housing unit, notifying a second host computer making access to the second housing portion different from the first housing portion that the storage medium has been conveyed to the turnout housing unit; and controlling the robot to convey the storage medium that has been conveyed to the turnout housing unit, to the second housing portion based on a medium conveyance instruction from the second host computer.

The turnout housing unit may be a medium access station acting as an inlet for the storage medium inserted into the housing unit and acting as an outlet for the storage medium ejected from the housing unit. The turnout housing unit may be a common housing portion included in common in the first housing portion and the second housing portion. The housing unit may be physically divided so as to correspond to the logical dividing, and the turnout housing unit may be a medium delivering mechanism for mediating the delivering of the storage medium between the first housing portion and the second housing portion which are divided physically.

In order to achieve the above object, according to a second aspect of the present invention there is provided a library apparatus comprising a logically plurally divided housing unit; a turnout housing unit for housing temporarily a storage medium; a robot for conveying the storage medium from the housing unit to the turnout housing unit or from the turnout housing unit to the housing unit; a robot controlling unit for, based on a medium conveyance instruction from a first host computer making access to a first housing portion of the logically plurally divided housing unit, controlling the robot to convey the storage medium from the first housing portion to the turnout housing unit, and thereafter based on a medium conveyance instruction from a second host computer making access to a second housing portion different from the first housing portion of the logically plurally divided housing unit, controlling the robot to convey the storage medium that has been conveyed to the turnout housing unit to the second housing portion; and a completion notifying unit for notifying the second host computer that the storage medium has been conveyed to the turnout housing unit, after completion of the conveyance of the storage medium from the first housing portion to the turnout housing unit.

As a result, it is possible to considerably reduce the time, personnel, the number of steps and cost necessary for the data transfer work between a plurality of host computers connected to the least change made to a conventional library apparatus.

### BRIEF DESCRIPTION OF THE DRAWINGS

The above and other objects, aspects, features and advantages of the present invention will become more apparent from the following detailed description when taken in conjunction with the accompanying drawings, in which:

FIG. 1 illustrates a library apparatus of a first embodiment applied with a method of the invention;

FIG. 2 illustrates a volume access station (VAS);

FIG. 3 shows an example of the composition of a library apparatus used for explanation of the addressing;

FIG. 4 illustrates an example of the addressing in a main frame system;

FIG. 5 illustrates an example of the addressing in an open system;

FIG. 6 is a time-chart showing the operation of a data transfer operation;

FIG. 7 is a flowchart illustrating the operation of a controller in the first embodiment;

FIG. 8 illustrates a library apparatus of the second embodiment applied with a method of the invention;

FIG. 9 illustrates a library apparatus of the third embodiment applied with the method of the invention;

FIG. 10 is a flowchart illustrating the operation of a controller in the third embodiment; and

FIG. 11 shows an example of the composition of the controller.

### DESCRIPTION OF THE PREFERRED EMBODIMENTS

Embodiments of the present invention will now be described with reference to the accompanying drawings. It is however to be understood that the technical scope of the invention is not limited to such embodiments.

According to the invention, the work time necessary for data transfer between a plurality of host computers is reduced by automatically notifying a host computer to be the destination of the data transfer, of insertion of a storage medium after the storage medium has been conveyed from transfer origin housing unit to which the host computer to be the origin of the data transfer makes an access to a turnout housing unit for housing temporarily a storage medium.

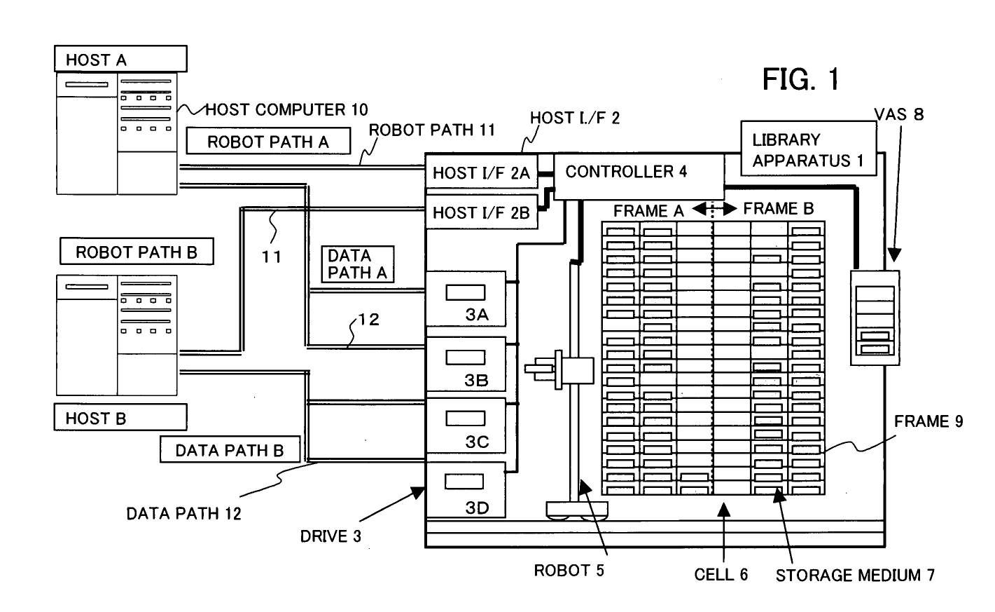

FIG. 1 illustrates a library apparatus of a first embodiment applied with a method of the invention.

Two (2) host computers (a host A, a host B) are connected to a library apparatus 1 and a housing unit (hereinafter referred to as “frame 9”) in which a plurality of storage media 7 are housed is logically divided into two (2) frames of frame A and frame B. The frame 9 is segmented into a plurality of rooms and each of the rooms is referred to as cell 6. Zero (0) or one (1) storage medium 7 is housed in the cell 6. The host A makes an access to the frame A assigned to the host A and uses storage media 7 housed in the cell 6 contained in the frame A. Similarly, the host computer B makes an access to the frame B and uses storage media 7 housed in the cell 6 contained in the frame B. The host A can not use the storage media housed in the frame B and vice versa.

In addition to the frame 9, the library apparatus 1 shown in FIG. 1 has a plurality of drives 3A-3D for reading out data stored in the storage medium 7 and writing data in the storage medium 7, a robot 5 for conveying a storage medium 7, a VAS (Volume Access Station) 8 for functioning as an outlet when ejecting the storage medium 7 out of the library apparatus or as an entrance when the storage medium is inserted into the library apparatus, host interfaces (host I/Fs) 2A-2B for connecting with host computers and a control unit (controller) 4 for controlling the library apparatus. The operation of the library apparatus 1 can be carried out through a touch panel operation board, not shown, installed in the library apparatus 1 or a GUI (Graphical User Interface) of a display apparatus not shown connected to a host computer, etc. in addition to instruction orders from a host computer 10.

A transmission path connecting the host computer 10 and the host interface I/F2 is called “robot path 11” and instruction orders (such as instruction to convey a medium, etc.) from the host computer 10 are transmitted through it. When the controller 4 has received an instruction to convey a medium, the controller 4 instructs the robot 5 to house a predetermined storage medium 7 into the drive 3. Then, when the data read out from the storage medium 7 housed in the drive 3 by the robot 5 has been transmitted through a transmission path called a data path 12 connecting the host computer 10 and the drive 3, or when writing of the data transmitted from the host computer 10 through the data path 12 has been completed, the robot 5 returns the storage medium 7 in the drive 3 to its original cell 6 and the process is finished.

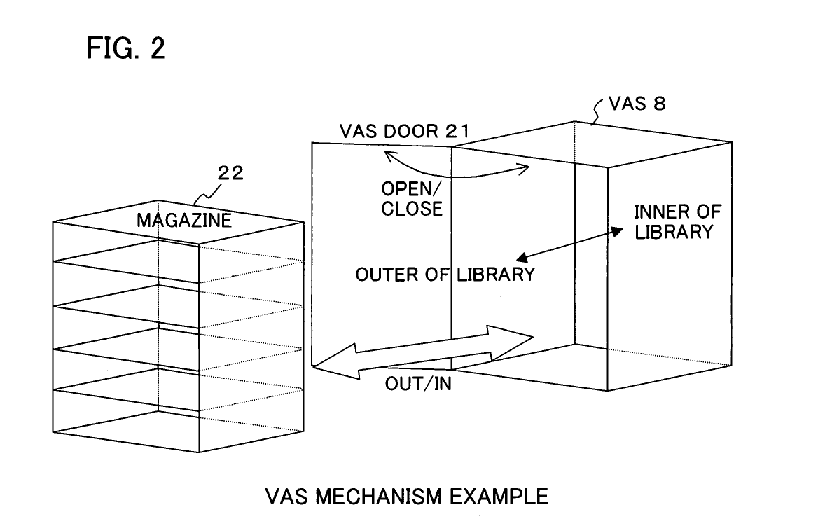

The processes of ejection and insertion of the storage medium housed in the library apparatus is executed through the VAS 8. FIG. 2 illustrates the VAS 8. VAS 8 has a mechanism in which a magazine 22 capable of housing the plurality of storage media 7 can be taken out through an open/close VAS door 21. When a new storage medium 7 is inserted, the storage medium 7 is housed in the magazine 22 having been taken out, the magazine 22 is inserted into the VAS 8 and the VAS door 21 is closed. The opening and closing of the door is sensed by a sensor not shown. Insertion of the new storage medium 7 is notified to the library apparatus 1 and the host computer 10 by closing the VAS door 21. In this manner, it is possible to house the storage medium 7 inserted, in the cell 6. On the contrary, when the storage medium 7 housed in the cell 6 is ejected, the VAS door 21 is opened and the magazine 22 is taken out after the storage medium 7 has been conveyed by the robot 5 from the cell 6 to the VAS 8. As a replaceable storage medium, a magnetic tape, an optical magnetic disk, an optical disk, a magnetic disk, a replaceable hard disk or etc. can be used.

Conventionally, an operator opens and closes the VAS door 21 and, without waiting for these operations, the host computer to be the destination of data transfer can not issue any instruction to convey a storage medium to the transfer destination housing unit. The locations where the library apparatus, the transfer destination host computer and the transfer origin host computer are installed are rather often far away from each other and, therefore, the operator has to shuttle between the host computers and the library apparatus resulting in needing a long time for data transfer work.

Next, a data transfer process in a library apparatus of the first embodiment will be described. According to the first embodiment, the VAS 8 is utilized as a turnout housing unit. That is, when the controller 4 included in the library apparatus 1 has received an instruction to convey the storage medium to the VAS 8, the host computer to be the destination of data transfer can sense insertion of a new storage medium into the VAS without opening and closing the VAS door 21 by notifying the host computer from the controller 4 of the insertion of the storage medium immediately after the conveyance to the VAS 8, and the work time for the data transfer between a plurality of host computers connected to the library apparatus 1 is reduced. Therefore, it is necessary to determine whether the destination of the conveyance contained in the medium conveyance instruction is the VAS or not.

Therefore, an addressing (address system) for the case where the location of the destination of conveyance of a storage medium is designated in the library apparatus 1 will be briefly described first. The host computer 10 designates the address of the conveyance destination when it issues a medium conveyance instruction using a command etc. The addressing considerably differs between OSs (Operating Systems) of a main frame system and an open system. An example of each of them will be given.

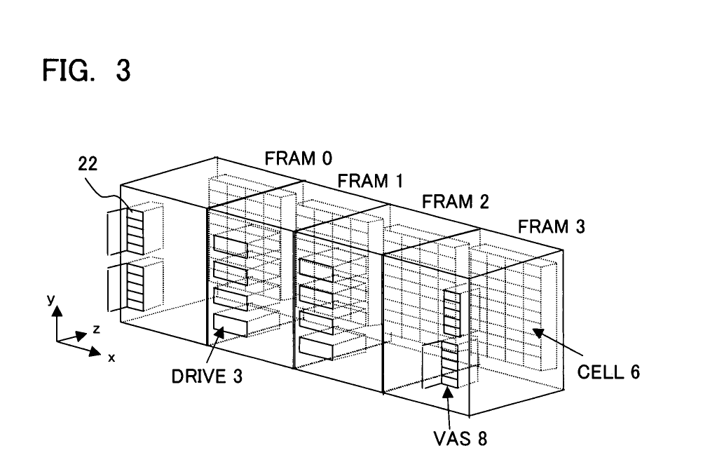

FIG. 3 shows an example of the composition of a library apparatus used for the explanation of the addressing. The apparatus includes four (4) VASs 8, eight (8) drives 3 and four (4) frames 9 (hereinafter, referred to as “frame”). The magazine 22 capable of housing five (5) storage media 7 can be inserted into each of the VAS 8. Each frame contains a plurality of cells 6. In this case, the number of the cells is 60 consisting of ten (10) series of cells vertically and six (6) series of cells laterally.

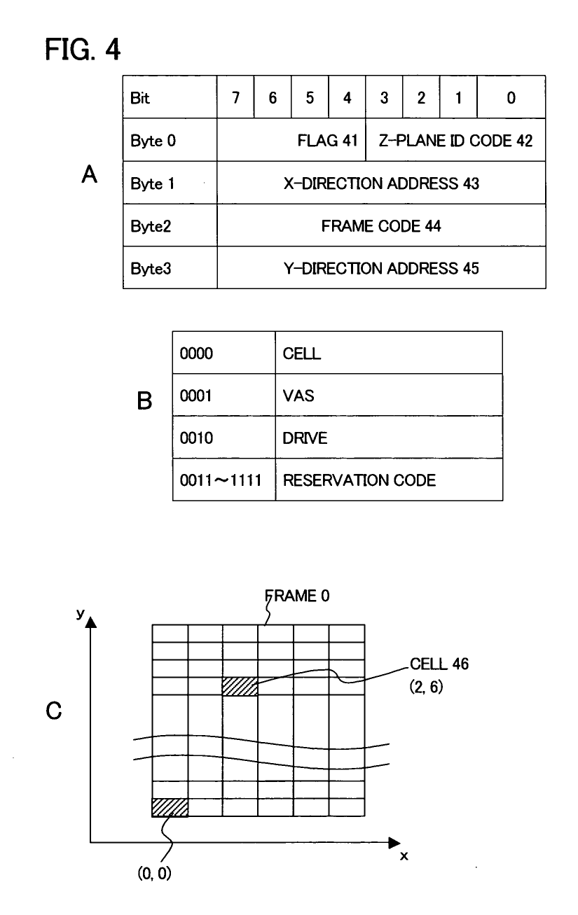

FIG. 4A illustrates an example of the addressing in a main frame system. An address is of four (4) bytes. A flag 41 is a code for identifying a frame (cell), a VAS and a drive and is interpreted as shown in FIG. 4B. That is, 0000 means the cell 6, 0001 means the VAS 8 and 0010 means the drive 3. Reservation codes 0011-1111 are unused codes reserved for future use.

A Z-plane identification code 42 is a code for which 0 denotes the drive/VAS side and 1 denotes the frame side. A frame code 44 is a code for specifying a frame. In the case of FIG. 3, frames are numbered as frame 0, frame 1, frame 2 and frame 3 from the left and binary values each corresponding to a frame number are stored in the frame code 44.

FIG. 4C illustrates an X-direction address 43 and a Y-direction address 45. Toward the side on which the Z-plane identification code is “1”, the lower left portion of each frame is denoted as X=0 and Y=0, the portion on the right of it is denoted as X=1 and Y=0 and the portion above it is denoted X=0 and Y=1. For example, the X-direction address 43 and the Y-direction address 45 of a cell 46 shown in FIG. 4C are denoted as (X, Y)=(2, 6). The binary values of this coordinate are stored in the X-direction address 43 and the Y-direction address 45. In the main frame system, the destination of conveyance of a storage medium 7 is designated by the above addressing example.

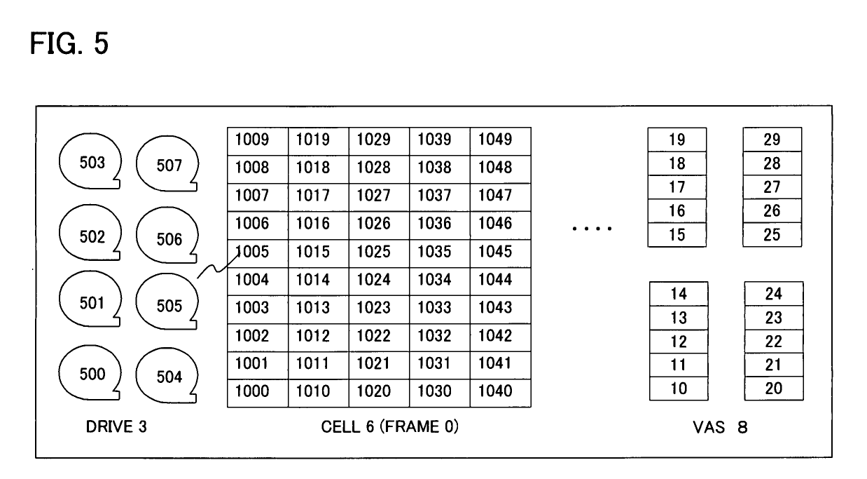

FIG. 5 illustrates an example of the addressing in an open system. The difference from that of the main frame system is that addresses are determined based on a physical arrangement of drives and VASs in the main frame system while addresses are expressed with a series of consecutive address numbers in a predetermined range in the open system. For example, the VASs are numbered with a series of consecutive numbers of ten (10) and larger ones, the drives are numbered with a series of consecutive numbers of 500 or larger ones and the cells are numbered with a series of consecutive numbers of 1000 or larger ones, and their addresses are designated by corresponding binary values.

In FIG. 5, it is depicted that a series of consecutive numbers from 500 to 507 are given to the eight (8) drives, a series of consecutive numbers from 1000 to 1059 are given to each of the cells contained in the frame 0 and a series of consecutive numbers from 10 to 29 are given to each stage of the magazine 22 contained in the four (4) VASS 8 shown in FIG. 3. However, each of the cells contained in frames other than the frame 0 is also consecutively numbered though omitted in FIG. 5. In the open system, the conveyance destination of the storage medium 7 is designated by an addressing exemplified above.

Next, operation in a data transfer process will be described. In the library apparatus 1 in the first embodiment, either one of two (2) operation modes is selected in advance through such as a display apparatus having a touch panel or GUI displayed on a display apparatus of each host computer and the like. The two (2) operation modes are a normal mode in which the controller 4 executes ejection to the VAS 8 and waits for opening or closing of the VAS door 21 when the controller 4 has received an instruction for conveyance to the VAS 8, and a data transfer mode in which insertion of a new storage medium is notified to a host computer immediately after the ejection to the VAS 8.

Furthermore, as to the data transfer mode, from which host computer to which host computer among the plurality of host computers connected through the host I/F data transfer is executed is set as data transfer origin information and data transfer destination information. Setting information containing mode information indicating which mode is selected currently, transfer origin information and transfer destination information is stored in, for example, an RAM equipped to the controller. In order to maintain the information over a power source ON/OFF cycle, it is possible to store the setting information in a non-volatile memory such as a flash memory before turning off the power of the library apparatus, and reading out the setting information stored in the non-volatile memory and store it in a RAM etc. after turning on the power.

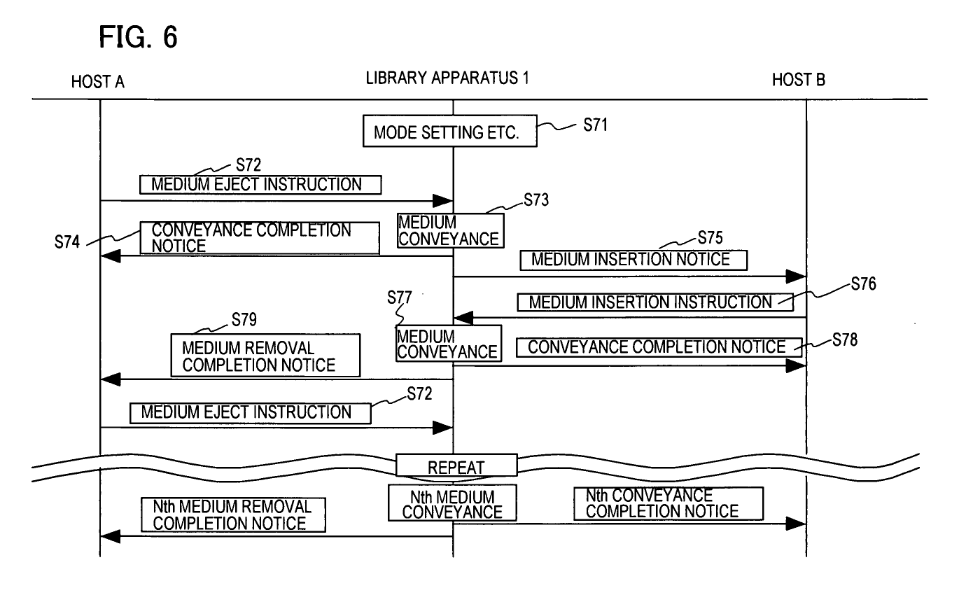

FIG. 6 is a time-chart showing the operation of the host A, the host B and the library apparatus 1 in the case where data transfer from the host A to the host B shown in FIG. 1 is executed. In advance, in the library apparatus 1, the data transfer mode is set, the host A is set as the transfer origin information and the host B is set as the transfer destination information (S71).

A medium conveyance instruction from the host A to the VAS 8 is issued (S72). In the library apparatus 1, the medium conveyance instruction is received and the robot 5 conveys a predetermined storage medium 7 from the frame A to the VAS 8 (S73). When the controller 4 has confirmed that the conveyance to the VAS 8 has been completed in the Step 73, the controller 4 notifies the host A of the completion of the conveyance (S74). The controller 4 also notifies the host B to be the data transfer destination of the completion of insertion of a new storage medium to the VAS 8 (S75). Conventionally, the host B can not instruct conveyance of a storage medium housed in the VAS 8 without waiting for a notice offered by opening or closing of the VAS door 21. However, in the embodiment of the invention, an instruction for conveyance from the VAS 8 to the frame B is issued by the host B in response to the receipt of the notice of Step S75 (S76).

In the library apparatus 1, in response to the receipt of the medium conveyance instruction, the robot 5 conveys the storage medium 7 conveyed in Step S73 from the VAS 8 to the frame B (S77). When the controller 4, has confirmed that the conveyance to the frame B has been completed in Step S77, the controller 4 notifies the host of the completion of the conveyance (S78). The controller 4 also notifies the host A being the data transfer origin of removal of the storage medium (S79). Due to Step S79, it is notified to the host A that the storage medium conveyed to the VAS has been removed and the VAS is in an EMPTY state. In the case where there are a plurality of storage media to/from which data is transferred, the processes of the above steps from Step S72 to Step S79 are repeated.

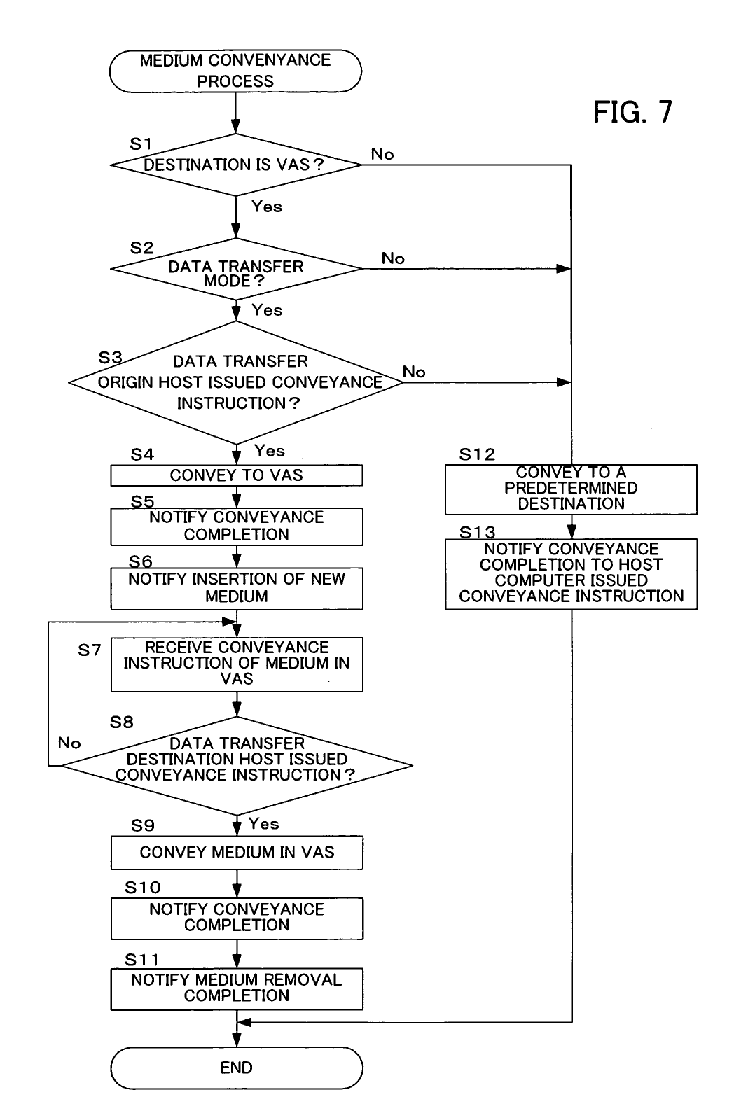

Next, the operation of the controller 4 included in the library apparatus 1 when it receives a medium conveyance instruction will be described. FIG. 7 is a flowchart of the operation. In advance, in the library apparatus in the first embodiment, either one of the data transfer mode or the normal mode has been set. It is assumed that, in the data transfer mode, data transfer from the host A (data transfer origin) to the host B (data transfer destination) is set to be executed.

First, the controller 4 determines whether the transfer destination is the VAS 8 or not (Si). Whether the transfer destination is the VAS or not can be determined by confirming whether the address set for the VAS is designated as that of the transfer destination. For example, as the addressing shown in FIG. 4, it is enough to determine whether the flag 41 of the conveyance destination address contained in the medium conveyance instruction is 0001 or not, or to determine whether conveyance destination address is any one of 10 to 29 indicating the VAS 8 as shown in FIG. 5 or not in the case where the conveyance destination is not the VAS 8, processes of the normal mode are executed.

In the case where the conveyance destination is the VAS 8 in Step S1, next, the controller confirms the operation mode having been set (S2). When the operation mode confirmed in Step S2 is the data transfer mode, whether a medium conveyance instruction has been issued from the host A or not is determined (S3). This is because the data transfer from the host A to the host B is set and, if the instruction for conveyance to the VAS has been issued from another host, it is enough to execute the processes of the normal mode.

In the case where the medium conveyance instruction has been issued from the host A in Step S3, the controller 4 instructs the robot 5 to convey to the VAS 8 the storage medium 7 housed in a predetermined cell 6 in the frame A (S4). When the controller 4 has detected that the storage medium 7 has been conveyed to the VAS 8, the controller 4 notifies the host A of the completion of the conveyance to the VAS 8 (S5) and notifies the host B to be the data transfer destination of the insertion of a new storage medium (S6).

Thereafter, the controller 4 waits for an instruction for medium conveyance from the VAS 8 issued by the host to be the data transfer destination (in this case, the host B) (S7 and S8). Then, according to a medium conveyance instruction issued from the host B having received the notice in Step S5, the controller 4 instructs the robot to convey the storage medium 7 housed in the VAS 8 in Step S4 to a predetermined cell 6 in the frame B (S9). When the controller 4 has detected that the storage medium 7 has been conveyed to the predetermined cell 6 in the frame B, the controller 4 notifies the host B of the completion of the conveyance (S10) and notifies the host A of the removal of the storage medium (S11). In this manner, the processes for the data transfer mode have been finished and the controller 4 prepares for the next conveyance instruction. In the case where there are a plurality of storage media to/from which data is transferred, the processes of the above steps from Step S1 to Step S11 are repeated.

In the case where the conveyance destination is not the VAS 8 in Step S1, where the operation mode is the normal mode in Step S2 and where the conveyance instruction is not issued from the host to be the data transfer origin in Step S3, the processes for the normal mode are executed. First, the controller 4 instructs the robot 5 to convey the storage medium 7 housed in a predetermined cell to a predetermined conveyance destination (S12). In the case where the processes are proceeded from Step S2 and Step S3 to Step S12, the conveyance destination is the VAS 8 and, in other cases, the storage medium is conveyed to conveyance destination designated by the address contained in the medium conveyance instruction. Then, when the controller 4 has detected that the storage medium 7 has been conveyed to the predetermined conveyance destination, the controller 4 notifies the host computer having issued the medium conveyance instruction of the completion of the conveyance (S13). In this manner, the processes for the normal mode have been finished and the controller 4 prepares for the next conveyance instruction.

As described above, since it is not necessary to execute opening and closing operations of the VAS door 21 after ejecting to VAS 8 in the data transfer work, the time for data transfer work from the host A to the host B can be considerably reduced. It is also contemplated that the move of a storage medium from the frame A to the frame B is executed directly and not through the VAS 8 (direct conveyance). However, the following effects can be obtained by executing the above control through the VAS 8. First, for an existing library apparatus 1, the control of the library apparatus 1 for insertion and ejection processes using the VAS 8 is already established. Therefore, in the implementation of the invention, the existing system interface etc. can be appropriated and the implementation can be coped with by a change of firmware. That is, it is possible to minimize the portion to be changed.

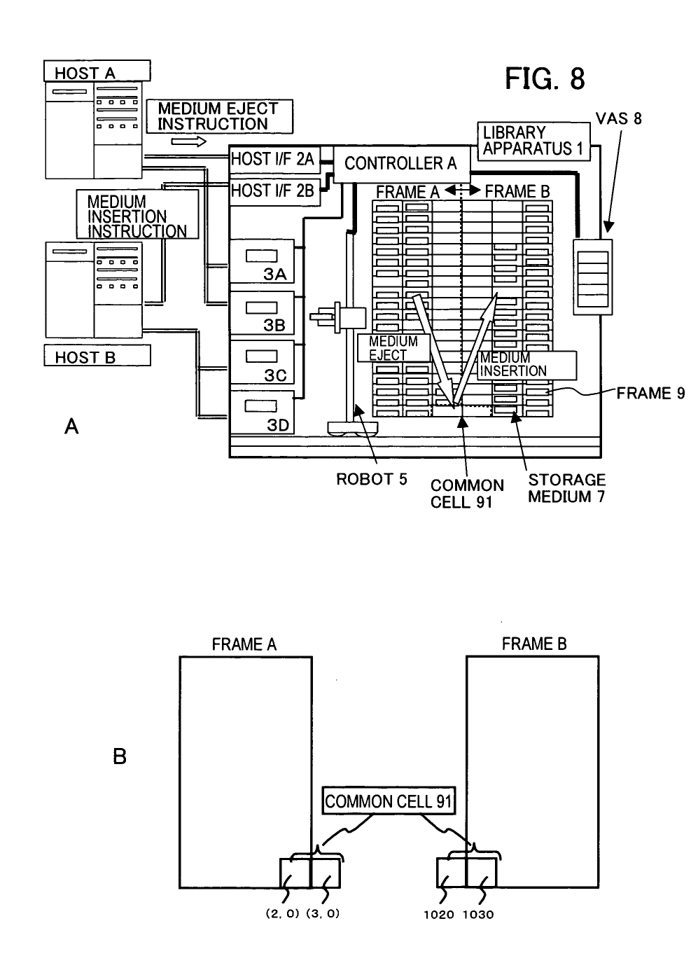

Furthermore, measures against abnormal states such as a failure occurred to the robot during the conveyance can be easily taken and unnecessary timeout can be avoided by dividing the transfer process from the frame A to the frame B into two (2) sequences of one from the frame A to the VAS and the other from the VAS to the frame B. In the case of the processes shown, in FIG. 8, they are divided into two (2) parts of the conveyance from the frame A to the VAS 8 (from Step S1 to Step S5) that relates to the control of the host A, and the conveyance from the VAS 8 to the frame B (from Step S6 to Step S11) that relates to the control of the host B. Therefore, division of problems can be carried out smoothly when an error has occurred and it can be made clear that which host should cope with the error. If the processes are executed without dividing them into two (2) sequences, when the instruction issued by the host B for the conveyance from the VAS 8 is delayed after the storage medium 7 has been conveyed to the VAS 8 by a conveyance instruction issued by the host A, a timeout may occur at the host A. According to the embodiment, since the completion of the conveyance to the VAS 8 is notified to the host A when the conveyance to the VAS 8 executed in response to the medium conveyance instruction issued by the host A has been completed (Step S5), no timeout occurs at the host A and it is not necessary to execute any error handling accompanying a timeout.

Next, a library apparatus of a second embodiment applied with a method of the invention will be described. In the first embodiment, the volume access station (VAS) is used as a turnout housing unit. However, in the second embodiment, a cell included commonly in a plurality of frames having different addressing (common cell) is used as a turnout housing unit. Therefore, the operation in the second embodiment can be described by reading the word “VAS 8” in the operation of the first embodiment as “common cell”.

FIG. 8A illustrates a library apparatus of the second embodiment applied with a method of the invention. What differs from the first embodiment is that, in the two logically divided frames of the frame A and frame B, a common cell contained in both of the frames exists. The basic composition except that does not differ from that of the first embodiment (FIG. 1). For example, it is assumed that the frame A has an addressing as shown in FIG. 4 and the frame B has an addressing as shown in FIG. 5. The X-direction address and the Y-direction address in FIG. 4, (2, 0) and (3, 0) correspond to the cell address 1020 and 1030 in FIG. 5 and this is the common cell (see FIG. 8B).

Next, the operation of the host A, the host B and the library apparatus 1 in the case where data transfer from the host A to the host B shown in FIG. 8 is executed will be described, reading as necessary the word “VAS” as “common cell” referring to FIG. 6. In advance, the data transfer mode has been set in the library apparatus and the host A has been set as transfer origin information, and the host B has been set as transfer destination information (S71).

A medium conveyance instruction from the host A to a common cell 91 is issued (S72). In the library apparatus 1, the medium conveyance instruction is received and the robots 5 conveys a predetermined storage medium 7 from the frame A to the common cell 91 (S73). Whether there is an empty area or not can be determined by the controller 4 and the storage medium 7 is conveyed to either of the common cells that is empty. When the controller 4 has confirmed that the conveyance to the common cell 91 has been completed in the Step 73, the controller 4 notifies the host A of the completion of the conveyance (S74). The controller 4 also notifies the host B to be the data transfer destination of the completion of insertion of a new medium to the common cell (S75).

An instruction for conveyance from the common cell 91 to the frame B is issued by the host B in response to the receipt of the notice of Step S75 (S76). In the library apparatus 1, in response to the receipt of the medium conveyance instruction, the robot 5 conveys the storage medium 7 conveyed in Step S73 from the common cell 91 to the frame B (S77). When the controller 4 has confirmed that the conveyance to the frame B has been completed in Step S77, the controller 4 notifies the host B of the completion of the conveyance (S78). The controller 4 also notifies the host A being the data transfer origin of the removal of the storage medium (S79). In the case where there are a plurality of storage media to/from which data is transferred, the processes of the above steps from Step S72 to Step S79 are repeated.

Next, the operation of the controller 4 in the second embodiment will be described. This will be described replacing the VAS with the common cell as necessary referring to FIG. 7. In advance, in the library apparatus, either one of the data transfer mode or the normal mode has been set. It is assumed that, in the data transfer mode, data transfer from the host A (data transfer origin) to the host B (data transfer destination) is set to be executed. Furthermore, the address of the common cell 91 is stored in the controller 4 in advance.

First, the controller 4 determines whether the transfer destination contained in a medium conveyance instruction is the common cell 91 or not (S1). Whether the transfer destination is the common cell or not can be determined by confirming whether the address of the common cell is designated as the transfer destination. In the case where the conveyance destination is not the common cell 91, the processes of the normal mode are executed.

In the case where the conveyance destination is the common cell 91 in Step S1, next, the controller confirms the operation mode having been set (S2). When the operation mode confirmed in Step S2 is the data transfer modes whether a medium conveyance instruction has been issued from the host A or not is determined (S3). This is because the data transfer from the host A to the host B is set and, if the instruction for conveyance to the common cell 91 has been issued from another host, it is enough to execute the processes of the normal mode.

In the case where the medium conveyance instruction has been issued from the host A in Step S3, the controller 4 instructs the robot 5 to convey to the common cell 91 the storage medium 7 housed in a predetermined cell 6 in the frame A (S4). When the controller 4 has detected that the storage medium 7 has been conveyed to the common cell 91, the controller 4 notifies the host A of the completion of the conveyance to the common cell 91 (S5) and notifies the host B to be the data transfer destination, of the insertion of a new storage medium (S6). Thereafter, the controller 4 waits for an instruction for medium conveyance from the common cell 91 issued by the host to be the data transfer destination (in this case, the host B) (S7 and S8).

Then, according to a medium conveyance instruction issued from the host B having received the notice of Step S6, the controller 4 instructs the robot to convey the storage medium 7 housed in the common cell 91 in Step S4 to a predetermined cell 6 in the frame B (S9). When the controller 4 has detected that the storage medium 7 has been conveyed to the predetermined cell 6 in the frame B, the controller 4 notifies the host B of the completion of the conveyance (S10) and notifies the host A of the removal of the storage medium (S11). In this manner, the processes for the data transfer mode have been finished and the controller 4 prepares for the next conveyance instruction. In the case, where there are a plurality of storage media to/from which data is transferred, the processes of the above steps from Step S1 to Step S11 are repeated.

In the case where the conveyance destination is not the common cell 91 in Step S1, where the operation mode is the normal mode in Step S2 and where the conveyance instruction is not issued from the host to be the data transfer origin in Step S3, the processes for the normal mode are executed. First, the controller 4 instructs the robot 5 to convey the storage medium 7 housed in a predetermined cell in the frame A to a predetermined conveyance destination (S12).

In the case where the processes are proceeded from Step S2 and Step S3 to Step S12, the conveyance destination is the common cell 91 and, in other cases, the storage medium is conveyed to a conveyance destination designated by the address contained in the medium conveyance instruction. Then, when the controller 4 has detected that the storage medium 7 has been conveyed to a predetermined conveyance destination, the controller 4 notifies the host computer having issued the medium conveyance instruction of the completion of the conveyance (S13). In this manner, the processes for the normal mode have been finished and the controller 4 prepares for the next conveyance instruction.

In the second embodiment, using the common cell as the turnout housing unit, the same effect can be obtained as that of the first embodiment using the VAS as the turnout housing unit.

Next, a library apparatus of a third embodiment applied with a method of the invention will be described. The library apparatus of the third embodiment of the invention is a library system in which the housing unit is also divided physically and the physically-divided portions of the housing unit are coupled by a medium delivering mechanism. A controller having received a conveyance instruction to the medium delivering mechanism notifies the insertion of a new storage medium immediately after the conveyance to the medium delivering mechanism. Thereby, the work time for data transfer between a plurality of host computers connected to the library apparatus is reduced. That is, the medium delivering mechanism is used as the turnout housing unit in the first or the second embodiments.

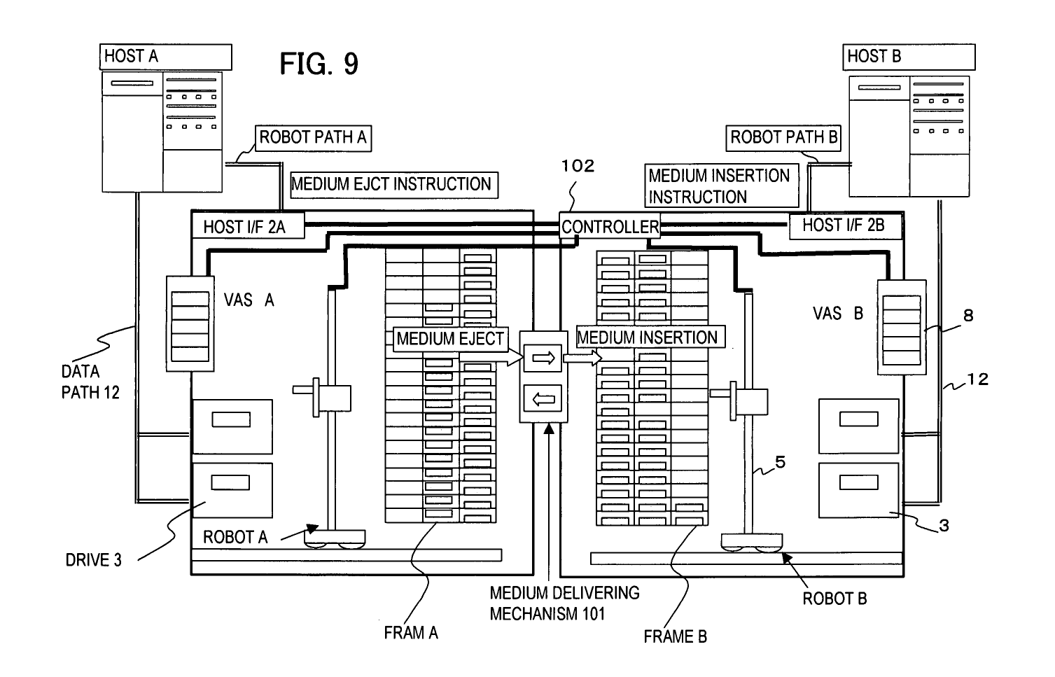

FIG. 9 illustrates a library apparatus of the third embodiment. The frame A and the frame B are coupled by a medium delivering mechanism 101 and a storage medium is moved to a different frame through this medium delivering mechanism. Except that, the VAS 8, the frame 9, the cell 6, the drive 3 and the hostI/F 2 are same as those of the first embodiments (FIG. 1) and, description for them is omitted. In the embodiment, since one (1) controller exists in each body including the physically divided housing unit, there are two (2) controllers in the coupled library apparatus shown in FIG. 9. However, one (1) of them exist as a back-up controller not shown and is used only when a controller 102 is out of order.

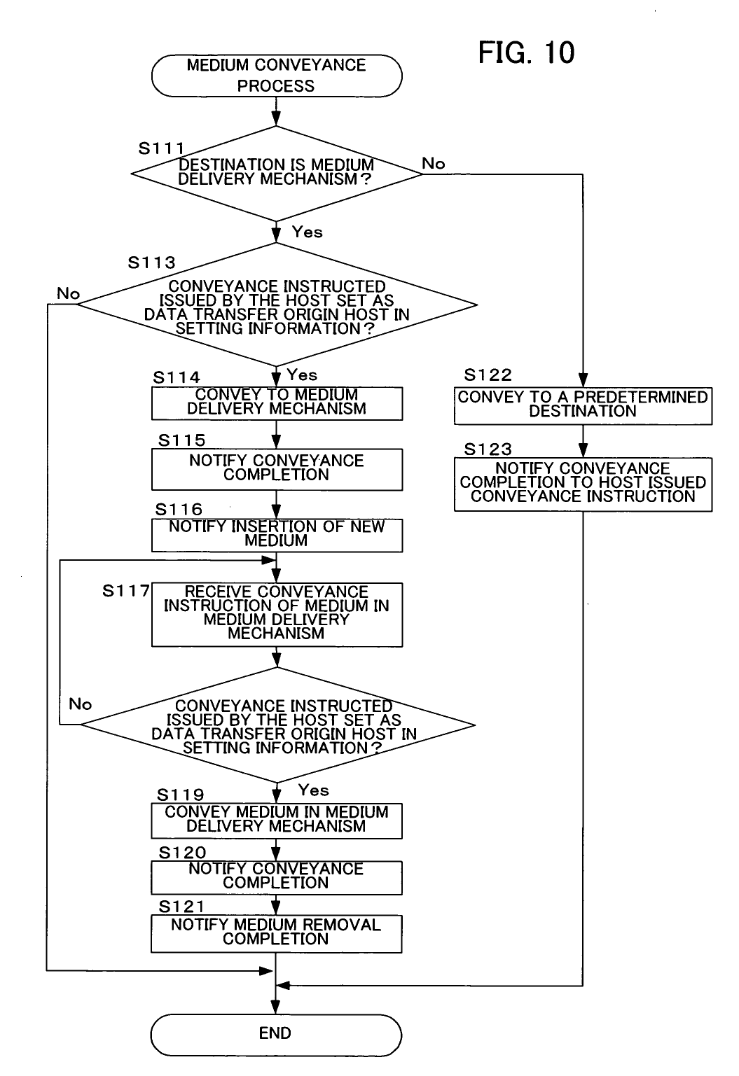

FIG. 10 is a flowchart illustrating the operation of the controller when it receives a conveyance instruction for the medium delivering mechanism. When the controller has received a medium conveyance instruction, the controller determines whether the conveyance destination is the medium delivering mechanism or not (S111). Similarly to the first and the second embodiments, an address is set in the medium delivering mechanism in the library system shown in FIG. 9 and, therefore, it is enough to confirm whether the address is designated as the conveyance destination or not. In the case where the conveyance destination is the medium delivering mechanism in Step S111, whether the medium conveyance instruction has been issued from the host A or not (S113). This is because a data transfer from the host A to the host B is set and, if the conveyance instruction for the medium delivering mechanism has been issued from another host, it is enough that the processes for the normal mode are executed.

In the case the medium conveyance instruction is issued from the host A in Step S113, the controller 102 instructs a robot A to convey to the medium delivering mechanism 101 the storage medium 7 housed in a predetermined cell 6 in the frame A (S114). When the controller 4 has detected that the storage medium 7 has been conveyed to the medium delivering mechanism 101, the controller 4 notifies the host A of the completion of the conveyance to the medium delivering mechanism 101 (S115) and also notifies the host B being the data transfer destination of the insertion of the medium into the storage medium delivering mechanism (S116). Thereafter, the controller waits for an instruction for medium conveyance from the medium delivering mechanism 101 issued by the host B being the data transfer destination (S117 and S118).

Then, according to a medium conveyance instruction issued from the host B having received the notice in Step S116, the controller 4 instructs the robot B to convey the storage medium 7 housed in the medium delivering mechanism 101 in Step S114 to a predetermined cell 6 in the frame B (S119). When the controller 4 has detected that the storage medium 7 has been conveyed to the predetermined cell 6 in the frame B, the controller 4 notifies the host B of the completion of the conveyance (S120) and notifies the host A of the removal of the storage medium (S121). In this manner, the processes for the data transfer have been finished and the controller 4 prepares for the next conveyance instruction. In the case where there are a plurality of storage media to/from which data is transferred, the processes of the above steps from Step S111 to Step S121 are repeated.

In the case where the conveyance destination is not the medium delivering mechanism 101 in Step S111, the controller 4 instructs any of the robots 5 to convey the storage medium 7 housed in a predetermined cell 6 to a predetermined conveyance destination contained in the medium conveyance instruction (S12). Then, when the controller 4 has detected that the storage medium has been conveyed to the predetermined conveyance destination, the controller 4 notifies the host computer having issued the medium conveyance instruction of the completion of the conveyance (S123). In this manner, the controller 4 prepares for the next conveyance instruction.

In the case where the conveyance instruction has been not issued from the host A in Step S113, no process is executed and the conveyance instruction is cancelled.

According to the third embodiment, by only designating the medium delivering mechanism as the conveyance destination, data transfer can be executed properly and the work time etc. can be reduced because the conventional VAS door open/close operations are not necessary.

According to the embodiments described above, it is possible to considerably reduce the time, personnel, the number of steps and cost necessary for the data transfer work between a plurality of host computers connected to the library apparatus, with the least change made to a conventional library apparatus.

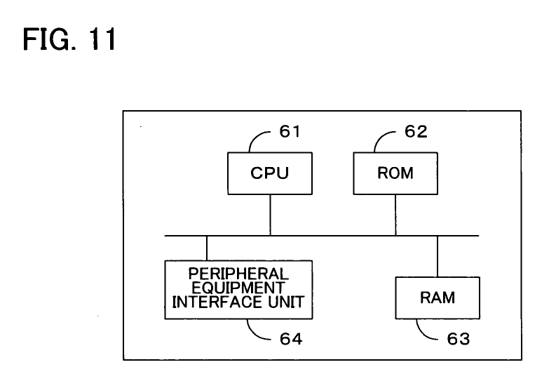

FIG. 11 shows an example of the composition of the controller 4 included in the library apparatus of the first to the third embodiments. A CPU 61 is a processor for executing management of the storage medium 7 housed in the cell 6, control of the robot 5, management of the state of the drive 3, control of the VAS 8 etc. by executing a control program (firmware) stored in an ROM 62. Upgrading such as addition of functions is possible by employing a flash memory, an EEPROM (Electronically Erasable and Programmable Read only Memory) etc. as the ROM 62.

An RAM 63 is storage means in which the result of calculation by the CPU 61, written-in data from the host computer 10 etc. are stored. A peripheral equipment interface unit 64 executes mediation between the controller 4 and various equipment connected to the controller 4. The peripheral equipment interface unit 64 has a physical connection connector according to the peripheral equipment connected and transmits information. The peripheral equipment is, for example, the VAS 8, the robot 5, the hostI/F 2, an input device such as a button or a touch panel, a display apparatus for displaying the state of the library apparatus, etc.

The method of the invention can be also realized as a program executed by a controller shown in FIG. 11. In the library apparatus of the first to the third embodiments, the control of the robot, and the notifying of the completion to the transfer destination host executed after conveying the storage medium to the turnout housing unit are both executed by the controller. However, the library apparatus may have a separated robot controlling unit and a completion notifying unit, and may distribute the processes.

While illustrative and presently preferred embodiments of the present invention have been described in detail herein, it is to be understood that the inventive concepts may be otherwise variously embodied and employed and that the appended claims are intended to be construed to include such variations except insofar as limited by the prior art.

1. A data transfer method effected in a library apparatus having a logically plurally divided housing unit, a turnout housing unit for housing temporarily a storage medium, and a robot for conveying the storage medium from the housing unit to the turnout housing unit or from the turnout housing unit to the housing unit, with a plurality of host computers being connected to the library apparatus, the plurality of host computers each making access to the logically plurally divided housing unit,
the data transfer method enabling the storage medium housed in a first housing portion of the logically plurally divided housing unit to be used by the host computer making access to a second housing portion different from the first housing portion, the method comprising the steps of:
controlling the robot to convey the storage medium from the first housing portion to the turnout housing unit based on a medium conveyance instruction from a first host computer making access to the first housing portion;
after completion of the conveyance to the turnout housing unit, notifying a second host computer making access to the second housing portion different from the first housing portion that the storage medium has been conveyed to the turnout housing unit; and
controlling the robot to convey the storage medium that has been conveyed to the turnout housing unit, to the second housing portion based on a medium conveyance instruction from the second host computer.

2. The data transfer method according to claim 1, wherein
the turnout housing unit is a volume access station acting as an inlet for the storage medium inserted into the housing unit and acting as an outlet for the storage medium ejected from the housing unit.

3. The data transfer method according to claim 1, wherein
the turnout housing unit is a common housing portion included in common in the first housing portion and the second housing portion.

4. The data transfer method according to claim 1, wherein
the housing unit is physically divided so as to correspond to the logical dividing, and wherein
the turnout housing unit is a medium delivering mechanism for mediating the delivering of the storage medium between the first housing portion and the second housing portion which are divided physically.

5. A library apparatus comprising:
a logically plurally divided housing unit;
a turnout housing unit for housing temporarily a storage medium;
a robot for conveying the storage medium from the housing unit to the turnout housing unit or from the turnout housing unit to the housing unit;
a robot controlling unit for, based on a medium conveyance instruction from a first host computer making access to a first housing portion of the logically plurally divided housing unit, controlling the robot to convey the storage medium from the first housing portion to the turnout housing unit, and thereafter based on a medium conveyance instruction from a second host computer making access to a second housing portion different from the first housing portion of the logically plurally divided housing unit, controlling the robot to convey the storage medium that has been conveyed to the turnout housing unit to the second housing portion; and
a completion notifying unit for notifying the second host computer that the storage medium has been conveyed to the turnout housing unit, after completion of the conveyance of the storage medium from the first housing portion to the turnout housing unit.

6. The library apparatus according to claim 5, wherein
the robot controlling unit and the completion notifying unit are included in a controlling unit for controlling the whole library apparatus.

7. The library apparatus according to claim 5, wherein
the turnout housing unit is a volume access station acting as an inlet for the storage medium inserted into the housing unit and acting as an outlet for the storage medium ejected from the housing unit.

8. The library apparatus according to claim 5, wherein
the turnout housing unit is a common housing unit included in common in the first housing portion and the second housing portion.

9. The library apparatus according to claim 5, wherein
the housing unit is physically divided so as to correspond to the logical dividing, and wherein
the turnout housing unit is a medium delivering mechanism for mediating the delivering of the storage medium between the first housing portion and the second housing portion which are divided physically.
